(19) United States
(12) Patent Application Publication
(10) Pub. No.: US 2025/0326947 A1
(43) Pub. Date: Oct. 23, 2025

(54) GAS BARRIER COATING FILMS

(71) Applicants: Dow Global Technologies LLC, Midland, MI (US); Rohm and Haas Company, Collegeville, PA (US); Dow Silicones Corporation, Midland, MI (US)

(72) Inventors: Sharon M. Vuong, Downingtown, PA (US); Shuang Qin, Downingtown, PA (US); Andrew B. Shah, Collegeville, PA (US); Rahul Shama, Pearland, TX (US); Manesh Nadupparambil Sekharan, Pearland, TX (US); Yuanqiao Rao, Berwyn, PA (US); Melinda L. Einsla, Royersford, PA (US); Qiangqiang Yan, Zhejiang (CN); Xiaomei Song, Shanghai (CN); Yafei He, Shanghai (CN); Hongyu Chen, Shanghai (CN); Brian R. Einsla, Collegeville, PA (US); Ray E. Drumright, Midland, MI (US); Xiangyi Zhang, Phoenixville, PA (US)

(21) Appl. No.: 18/703,542

(22) PCT Filed: Dec. 7, 2022
(86) PCT No.: PCT/CN2022/137309

§ 371 Date: Apr. 22, 2024

(30) Foreign Application Priority Data
Dec. 7, 2021 (WO) PCT/CN2021/136058

(51) Int. Cl. C09D 129/04; C08K 5/29; C09D 7/63

(52) U.S. Cl. CPC C09D 129/04; C08K 5/29; C09D 7/63

(57) ABSTRACT

A barrier coating comprising a polyvinyl alcohol, a polyacrylic acid, and a carbodiimide wherein the barrier film is formed at less than 120° C. is disclosed. A laminate comprising the barrier coating comprising a polyvinyl alcohol, a polyacrylic acid, and a carbodiimide is also disclosed. The polyacrylic acid can comprise a poly (meth) acrylic acid with a molecular weight from 2000 to 400,000 g/mol, and a degree of neutralization of from 2 to 50%. The polyvinyl alcohol can have a saponification degree of at least 80% and a molecular weight of from 10,000 to 300,000 g/mol. The disclosed barrier coating provides good OTR at high humidity without the need for high curing temperatures or non-commercially viable cure times.

### PRIORITY

The present application claims the benefit of International Application No. PCT/CN2021/136058, filed on Dec. 7, 2021.

### FIELD

The current disclosure relates to gas barrier coatings used in food production and storage. More specifically the current disclosure relates to PVOH containing gas barrier coatings used in food production and storage.

### INTRODUCTION

Freshness and quality of packed food is maintained by limiting oxygen and moisture permeability. Currently, plastic packaging is metallized or coated with thick gas barrier polymers such as PVOH, EVOH, or nylon. Metallization is an energy intensive process. Application of a primer coating is necessary if metallization is used which adds a processing step. The amount of these added materials also negatively impacts recyclability In addition, the oxygen transmission rate (OTR) increases at high humidity if PVOH is used. Fillers can increase the tortuosity of the path followed by gas diffusion molecules but can disperse poorly within the polymer matrix as well as lead to poor mechanical properties, such as flexibility, of the final packaging film. Crosslinking the PVOH has also been tried but this can lead to high curing temperatures which can damage the underlying plastic film, or non-commercially viable cure times.

Thus, a need exists for a gas barrier coating that is less energy intensive, allows recycling, has good OTR at high humidity, doesn't disrupt the mechanical properties of the final film, and does not require high curing temperatures or non-commercially viable cure times.

### SUMMARY OF DISCLOSURE

A barrier coating comprising a polyvinyl alcohol, a polyacrylic acid, and a carbodiimide wherein the barrier film is formed at less than 120° C. is disclosed. A laminate comprising the barrier coating comprising a polyvinyl alcohol, a polyacrylic acid, and a carbodiimide is also disclosed.

### DETAILED DESCRIPTION

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1 to 7 above includes subranges 1 to 2; 2 to 6; 5 to 7; 3 to 7; 5 to 6; etc.).

The term “composition” refers to a mixture of materials which comprise the composition, as well as reaction products and decomposition products formed from the materials of the composition.

As used herein, the term “polymer” means a polymeric compound prepared by polymerizing monomers, whether of the same or a different type. The generic term polymer thus embraces the term homopolymer (employed to refer to polymers prepared from only one type of monomer), and the term copolymer or interpolymer. Trace amounts of impurities (for example, catalyst residues) may be incorporated into and/or within the polymer. A polymer may be a single polymer, a polymer blend, or a polymer mixture, including mixtures of polymers that are formed in situ during polymerization.

As used herein, the term “polyolefin” means a polymer that comprises, in polymerized form, a majority amount of olefin monomer, for example ethylene or propylene (based on the weight of the polymer), and optionally may comprise one or more comonomers.

“Polyethylene polymer”, “polyethylene-based polymer”, “PE-based polymer”, “polyethylene”, or “ethylene-based polymer” shall mean polymers comprising a majority amount (>50 mol %, or >60 mol %, or >70 mol % or >80 mol %, or >90 mol %, or >95 mol % or >97 mol %) of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE). These polyethylene materials are generally known in the art; however, the following descriptions may be helpful in understanding the differences between some of these different polyethylene resins.

The term “LDPE” may also be referred to as “high pressure ethylene polymer” or “highly branched polyethylene” and is defined to mean that the polymer is partly or entirely homo-polymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.935 g/cm3.

The term “LLDPE”, includes both resin made using the traditional Ziegler-Natta catalyst systems and chromium-based catalyst systems as well as single-site catalysts, including, but not limited to, bis-metallocene catalysts (sometimes referred to as “m-LLDPE”) and constrained geometry catalysts, and includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. Nos. 3,914,342 or 5,854,045). The LLDPEs can be made via gas-phase, solution-phase or slurry polymerization or any combination thereof, using any type of reactor or reactor configuration known in the art.

The term “MDPE” refers to polyethylenes having densities from 0.926 to 0.935 g/cm3. “MDPE” is typically made using chromium or Ziegler-Natta catalysts or using single-site catalysts including, but not limited to, bis-metallocene catalysts and constrained geometry catalysts, and typically have a molecular weight distribution (“MWD”) greater than 2.5.

The term “HDPE” refers to polyethylenes having densities greater than about 0.935 g/cm3 and up to about 0.970 g/cm3, which are generally prepared with Ziegler-Natta catalysts, chrome catalysts or single-site catalysts including, but not limited to, bis-metallocene catalysts and constrained geometry catalysts.

The term “ULDPE” refers to polyethylenes having densities of 0.880 to 0.912 g/cm3, which are generally prepared with Ziegler-Natta catalysts, chrome catalysts, or single-site catalysts including, but not limited to, bis-metallocene catalysts and constrained geometry catalysts.

“polypropylene-based polymer”, “PP-based polymer” or “propylene-based polymer” shall mean polymers comprising a majority amount (>50 mol %, or >60 mol %, or >70 mol % or >80 mol %, or >90 mol %, or >95 mol %) of units which have been derived from propylene monomer.

polyethylene terephthalate-based polymer”, or “PET-based polymer” shall mean polymers comprising a majority amount (>50 wt %, or >60 wt %, or >70 wt % or >80 wt %, or >90 wt %, or >95 wt %) of ethylene terephthalate.

“Polyolefin plastomer” can be a polyethylene plastomer or a polypropylene plastomer. Polyolefin plastomers include, for example, polymers made using single-site catalysts such as metallocenes and constrained geometry catalysts. Polyolefin plastomers have a density of 0.885 to 0.915 g/cm³. All individual values and subranges from 0.885 g/cm³ to 0.915 g/cm³ are included herein and disclosed herein; for example, the density of the polyolefin plastomer can be from a lower limit of 0.895, 0.900, or 0.905 g/cm³ to an upper limit of 0.905, 0.910, or 0.915 g/cm³. In some embodiments, the polyolefin plastomer has a density from 0.890 to 0.910 g/cm³.

“Polyolefin elastomer” can be a polyethylene elastomer or a polypropylene elastomer. The polyolefin elastomers have a density of 0.857 to 0.885 g/cm³. All individual values and subranges from 0.857 g/cm³ to 0.885 g/cm³ are included herein and disclosed herein; for example, the density of the polyolefin elastomer can be from a lower limit of 0.857, 0.860, 0.865, 0.870, or 0.875 g/cm³ to an upper limit of 0.870, 0.875, 0.880, or 0.885 g/cm³. In some embodiments, the polyoelfin elastomer has a density from 0.860 to 0.880 g/cm³.

“polyethylene-based film” or “PE-based film” refers to a film that comprises at least 90 weight percent of polyethylene, at least 95 weight percent of polyethylene, at least 97 weight percent of polyethylene based on the total weight of the film.

“polypropylene-based film” or “PP-based film” refers to a film that comprises at least 90 weight percent of polypropylene, at least 95 weight percent of polypropylene, at least 97 weight percent of polypropylene based on the total weight of the film.

“polyethylene terephthalate-based film” or “PET-based film” refers to a film that comprises at least 90 weight percent of polyethylene terephthalate, at least 95 weight percent of polyethylene terephthalate, at least 97 weight percent of polyethylene terephthalate based on the total weight of the film.

As used herein, an anti-oxidant is a compound included in polymeric films to stabilize the polymer(s) or prevent oxidative degradation of the polymer(s). Anti-oxidants are well known to persons of ordinary skill in the art.

As used herein, an antiblock agent is a compound that minimizes, or prevents, blocking (i.e., adhesion) between two adjacent layers of film. Blocking can cause issues, for example, during unwinding of a film roll. The use of antiblock agents is well known to persons of ordinary skill in the art. Examples of common antiblock agents include, without limitation, silica, talc, calcium carbonate, and combinations thereof.

As used herein, a slip agent is a compound added to a film to reduce friction between films and/or between films and equipment. Typical slip agents include migratory and non-migratory slip agents and are well to persons of ordinary skill in the art.

As used herein, the term “copolymer” means any polymer having two or more monomers.

As used herein the term “polyvinyl alcohol” means a polymer of a vinyl alcohol.

### Barrier Coating

Currently disclosed is a barrier coating wherein the barrier film is formed at less than or equal to 120° C. The barrier coating can comprise polyvinyl alcohol, polyacrylic acid, and a carbodiimide. The barrier coating can comprise a polyvinyl alcohol to polyacrylic acid ratio from 95:5 to 5:95. All internal subranges and values are disclosed. For example, the barrier coating can comprise a polyvinyl alcohol to polyacrylic acid ratio from 15:85 to 85:15, 30:70 to 70:30, or 50:50. The barrier coating can comprise 5wt. % carbodiimide. The barrier coating can comprise from 0.5 to 10% carbodiimide. The barrier coating can comprise waterborne coating additives such as but not limited to anti-block agents, defoamers, thickeners, and wetting agents.

A substrate coated in the barrier coating can have an OTR at 50% or higher relative humidity of less than 0.60 cc/m² day. A substrate coated in the barrier coating can have an OTR at 50% or higher relative humidity of from 0.60 to 0.04 cc/m² day. All internal values and subranges are disclosed. For example, a substrate coated with the barrier coating can have an OTR from 0.04 to 0.1 cc/m² day. The barrier coating can be applied to various substrates including but not limited to polyethylene, polypropylene, and polyethylene terephthalate.

The barrier coating can be formed at a temperature of less than 120° C. The barrier coating can be formed at a temperature between 50 and 119.9° C. All internal values and subranges are disclosed. For example, the barrier coating can be formed at a temperature between 80 to 119.9° C.

### Polyacrylic Acid

The polyacrylic acid can comprise at least one poly(meth)acrylic acid. The polyacrylic acid can comprise a copolymer of at least two polymers. The polyacrylic acid can comprise a copolymer of at least two monomers. The polyacrylic acid can comprise a mixture of at least two polymers.

The polyacrylic acid can have a number average (Mₙ) molecular weight of from 2000 to 400,000 g/mol. All internal values and subranges are included. For example, the polyacrylic acid can have a number average molecular weight (Mₙ) of from 20,000 to 300,000, or 40,000 to 200,000g/mol.

The polyacrylic acid can be partially neutralized. The polyacrylic acid can have a degree of neutralization of from 2 to 50%. All internal values and subranges are included. For example, the polyacrylic acid can have a degree of neutralization of from 5 to 20%. The polyacrylic acid can be partially neutralized using bases including but not limited to NaOH, KOH, NH₃·H₂O, ZnO, and CaO.

### Polyvinyl Alcohol

The polyvinyl alcohol can have a saponification degree of at least 80%. The polyvinyl alcohol can have a saponification degree of at least 95%. The polyvinyl alcohol can have a saponification degree of from 80 to 100%. All internal values and subranges are included. For example, the polyvinyl alcohol can have a saponification degree of from 95 to 100%.

The polyvinyl alcohol can have a molecular weight of from 10,000 to 300,000 g/mol. All internal values and subranges are disclosed. For example, the polyvinyl alcohol can have a molecular weight of from 50,000 to 200,000 g/mol.

The polyvinyl alcohol resin can have a saponification degree of at least 80% and a molecular weight (M_{w}) from 10,000 to 300,000 g/mol. The polyvinyl alcohol can have a saponification degree of at least 95% and a molecular weight (M_{w}) of from 50,000 to 200,000 g/mol.

### Substrate

The substrate can comprise a film. The film can have at least one layer comprising polyethylene. Other layers can be PP, nylon, or other plastics known to those of skill in the art. There can be one layer. Alternatively, there can be two or more layers. These two or more layers can be extruded together to form a film. There can be three (or three or more) layers. When there are three (or three or more) layers the layer on the outside is called a sealant layer, and the layer opposite the sealant layer is a skin layer, and a layer or layers between the skin and sealant layers is a core layer or core layers. When there is only one layer comprising, any of the compositions discussed herein as skin, core or sealant layers can be used. When there are only two layers, any combinations of skin layer and core layer, skin layer and sealant layer, or core layer and sealant layer can be used. When there are two or more layers, each layer can be immediately adjacent to at least one other, or an adhesive layer. The film can comprise a sealant layer. The film can comprise a skin layer, a core layer and a sealant layer.

The film can comprise a linear low density polyethylene (LLDPE), medium density polyethylene (MDPE), high density polyethylene (HDPE), a low density polyethylene (LDPE) as well as combinations of two or more of the foregoing. The film can comprise a Ziegler-Natta catalyzed, single site catalyzed (including, without limitation, metallocene), or Chromium catalyzed linear low density polyethylene (LLDPE), medium density polyethylene (MDPE), high density polyethylene (HDPE), an autoclave produced, or tubular produced low density polyethylene (LDPE) as well as combinations of two or more of the foregoing.

The film can further comprise at least one of an ultra-low density polyethylene, a polyolefin plastomer, a polyolefin elastomer, an ethylene vinyl acetate copolymer, an ethylene ethyl acrylate copolymer, an ethylene vinyl alcohol, and any polymer comprising at least 50% ethylene monomer, and combinations thereof.

A skin layer can comprise a polypropylene, nylon, liner low density polyethylene (LLDPE), medium density polyethylene (MDPE), high density polyethylene (HDPE), a low density polyethylene (LDPE) as well as combinations of two or more of the foregoing. This LLDPE can be a single site catalyzed polyethylene (such as, and without limitation, m-LLDPE). The skin layer can further comprise additives, such as, for example, antioxidants, ultraviolet light stabilizers, thermal stabilizers, slip agents, antiblock, pigments or colorants, processing aids, crosslinking catalysts, flame retardants, fillers and foaming agents.

A core layer can comprise a linear low density polyethylene (LLDPE), medium density polyethylene (MDPE), high density polyethylene (HDPE), a low density polyethylene (LDPE) as well as combinations of two or more of the foregoing.

A sealant layer can comprise a linear low density polyethylene (LLDPE), medium density polyethylene (MDPE), high density polyethylene (HDPE), a low density polyethylene (LDPE), polyolefin elastomers or plastomers, as well as combinations of two or more of the foregoing. The sealant layer can comprise a Ziegler-Natta catalyzed, single site catalyzed (including metallocene), or Chromium catalyzed linear low density polyethylene (LLDPE), medium density polyethylene (MDPE), high density polyethylene (HDPE), an autoclave produced or tubular produced low density polyethylene (LDPE) as well as combinations of two or more of the foregoing. The LLDPE can be a single site catalyzed polyethylene (e.g. mLLDPE). This can be an outer layer of the film. The sealant layer may advantageously include an anti-blocking agent. For example, an anti-block agent may be present in the sealant layer at an amount of at least about 200ppm, at least about 1000ppm or at least about 1500 ppm, In addition, slip agents (e.g. erucamide) may be helpful. For example, slip agents may be present in the sealant layer at an amount of less than 500ppm, or less than 300ppm, or less than 200ppm, less than 100ppm, or equal to 0 ppm, based on total weight of the sealant layer.

The film can be a blown film, a cast film, a machine direction oriented film or a biaxially oriented film. The film can be fabricated through blown, casting, water quenching, double bubble, or other techniques known to those of ordinary skill in the art such as those described in Film Processing Advances, Toshitaka Kanai and Gregory A. Campbell (editors), Chapter 7 (Biaxial Oriented Film Technology), pp. 194-229. After fabrication, the film may be subjected to machine direction orientation (MDO) or biaxial orientation processes to provide a machine direction oriented film or a biaxially oriented film, respectively.

The overall thickness of the film can be at least 10, at least 20, or at least 30 microns. The overall thickness of the film can be no more than 200, no more than 150, no more than 120, no more than 100, no more than 80, no more than 70, or no more than 60 microns.

The concentration of anti-oxidants in the film layer is less than 3000 ppm, or less than 2000 ppm, or less than 1500ppm, or less than 1300ppm, based on the total weight of the film.

### Production and Use

Solutions of PVOH and various bases can be obtained as understood in the art. Partially Neutralized PAA can be prepared by adding calculated amounts of a base solution to PAA solutions. The amount of base to be added depends on the degree of neutralization desired and the number of moles of PAA carboxyl groups present in the sample to be neutralized. The barrier coating can then be obtained by mixing the partially neutralized PAANa and PVOH by various methods understood in the art.

The solutions thus created can be coated using various means known in the art such as bar coating onto various substrates such as polyethylene, polypropylene, or polyethylene terephthalate at various film thicknesses depending on the application. The coated substrates obtained are useful in food packaging as well as any other application where an oxygen impermeable barrier is needed.

### Testing Procedures

### Vapor Sorption

Vapor sorption is measured using a VTI-SA+ Vapor Sorption Analyzer from TA Instruments. Thin film samples are peeled off from a substrate and dried at 60° C. for 24 hours. The equilibrium weight for each sample from 0% to 80% RH at 10% RH intervals is then measured at 25° C. with an equilibrium criterion of 0.0010 wt. % within 5 minutes and a maximum equilibration time of 180 minutes at each condition. The vapor sorption is calculated from the difference between the equilibrium weight at each condition and the dry weight of the film and expressed as a percentage.

### OTR Measurement

A MOCON Ox-Tran Model 2/21 was used to measure the oxygen transmission rate of the blend films according to ASTM D3985-05 at 23° C. and 50% relative humidity.

### WVTR Measurement

WVTR measurements are conducted on a Mocon Permatran-W™ Model 3/33 using the wet sponge method (100% RH) at 37° C. The test area was 50 cm². The testing procedure followed ASTM F1249.

### EXAMPLES

Table 1 below lists the materials used in the following examples. All DOW™ products are available from DOW™ chemical.

TABLE 1
Materials Used

| Commercial name | Component | Description | Supplier |
|---|---|---|---|
| POVAL ™ 28-98 | Polyvinyl alcohol | Polyvinyl alcohol powder; | Kuraray Company |
| | (PVOH) | degree of hydrolysis = 98-99%; | (Japan) |
| | | solution: pH: 5.0-7.0, viscosity: | |
| | | 25.0-31.0 mPa · s | |
| ELVANOL ™ 90-50 | Polyvinyl alcohol | Polyvinyl alcohol powder; | Kuraray Company |
| | (PVOH) | degree of hydrolysis = | (Japan) |
| | | 99.2-99.7%; solution: pH: 5.0-7.0, | |
| | | viscosity: 11.6-15.4 mPa · s | |
| Poly(acrylic acid) | Polyacrylic acid | 50% polyacrylic acid is water; | Acros Organics/Thermo |
| | (PAA) | MW = 5000 | Scientific |
| Desmodur ® XP 2802 | Polycarbodiimide | Waterborne dispersion of | Covestro AG |
| | | hydrophilically modified | |
| | | polyfunctional carbodiimide; | |
| | | viscosity: 30 mPa · s | |

### PVOH Thin Film Preparation

12 wt % PVOH solution is prepared by dissolving 24 grams of PVOH powder into 176 grams of deionized water at 95° C. for two hours. Crosslinkers and fillers are mixed with the solution using a FlackTek Mixer at 2000 rpm for 2-5 min.

### Coating Procedure

Prepared formulations are dispensed on PE or PET substrates with pipettes and spread with a 3 mil BYK drawdown bar. The coated samples are then dried in an oven at 90° C. for 1 hour yielding ˜9 μm dried films.

| | | | Example #1 |
|---|---|---|---|
| | | Comparative | PVOH + |
| | | Example #1 | PAA + |
| | Comparative | PVOH + | polycarbo- |
| | Example #0 | PAA | diimide |
| | PVOH on PE | on PE | on PE |
| POVAL ™ 28-98 PVOH | 100 | 81 | 76 |
| solution (11.5%) (%) | | | |
| PAA (50%) (%) | 0 | 19 | 19 |
| Desmodur ® XP 2802 | 0 | 0 | 5 |
| Oxygen Permeation | | | |
| (23° C., 50% RH) | 0.174 | 0.103 | 0.043 ± 0.007 |
| (cc · mil/m^{2·} day) | | | |
| Water Vapor | 1.38 | 1.57 | 1.48 |
| Permeation | | | |
| (37° C., 100% RH) | | | |
| (g · mil/m^{2·} day) | | | |
| Vapor Sorption (% | 18.41 | 14.67 | 19.64 |
| Water Uptake, 80% RH) | | | |

1. A barrier coating comprising a polyvinyl alcohol, a polyacrylic acid, and a carbodiimide wherein the barrier film is formed at less than 120° C.

2. The barrier coating of claim 1 wherein the polyacrylic acid comprises at least one poly(meth)acrylic acid.

3. The barrier coating of claim 1 wherein the polyacrylic acid has a molecular weight of from 2000 to 400,000g/mol.

4. The barrier coating of claim 1 wherein the polyacrylic acid has a molecular weight of from 20,000 to 300,000 g/mol.

5. The barrier coating of claim 1 wherein the polyacrylic acid has a molecular weight of from 40,000 to 200,000 g/mol.

6. The barrier coating of claim 1 wherein the polyacrylic acid is partially neutralized.

7. The barrier coating of claim 1 wherein the polyacrylic acid has a 2 to 50% degree of neutralization.

8. The barrier coating of claim 1 wherein the polyvinyl alcohol has a saponification degree of at least 80%.

9. The barrier coating of claim 1 wherein the polyvinyl alcohol has a saponification degree of at least 95%.

10. The barrier coating of claim 1 wherein the polyvinyl alcohol has a molecular weight of from 10,000 to 300,000 g/mol.

11. The barrier coating of claim 1 wherein the polyvinyl alcohol has a molecular weight of from 50,000 to 200,000 g/mol.

12. The barrier coating of claim 1 wherein the barrier coating has a polyvinyl alcohol to polyacrylic acid ratio from 95:5 to 5:95.

13. The barrier coating of claim 1 wherein the barrier coating has a polyvinyl alcohol to polyacrylic acid ratio from 15:85 to 85:15.

14. A laminate comprising the barrier coating in claim 1.
